(19) United States
(12) Patent Application Publication
(10) Pub. No.: US 2007/0200487 A1
(43) Pub. Date: Aug. 30, 2007

(54) EL DISPLAY APPARATUS HAVING COORDINATES DETECTING FUNCTION

(75) Inventor: Yoshinori Uno, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/676,125

(22) Filed: Feb. 16, 2007

(30) Foreign Application Priority Data
Feb. 24, 2006 (JP) 2006/048002
Feb. 5, 2007 (JP) 2007/025234

(51) Int. Cl. H05B 33/08; H05B 33/06

(52) U.S. Cl. 313/500; 313/505

(57) ABSTRACT

A thin type electroluminescence (EL) display apparatus having an electromagnetic induction type touch panel function is provided. The EL display apparatus includes: a first substrate; plural EL devices arranged on the first substrate; a second substrate arranged over the EL devices and separated apart from the EL devices; loop coils for detecting coordinates; a current detecting section for detecting current changes in the loop coils; and a coordinates detecting section for detecting a position on a display screen based on the current changes detected by the current detecting section in which the loop coils are arranged on a surface of the second substrate on the side of the first substrate.

### BACKGROUND OF THE INVENTION

1. Field of the Invention

The present invention is related to an electroluminescence (EL) display apparatus having a function of sensing a current produced by an electromagnetic induction to thereby detect a contact position of a position indicator.

2. Description of the Related Art

Conventionally, while liquid crystal display apparatuses having touch panel functions are known, organic EL display apparatuses equipped with pressure sensitive type touch panels are present in technical fields of organic EL (refer to Japanese Patent Application Laid-Open No. H10-091342).

As the related art, such a position detecting apparatus has been proposed (refer to Japanese Patent Application Laid-Open No. S63-070326). That is, the position detecting apparatus has a function of detecting a position of a position indicator on a display screen by transmitting and receiving electromagnetic waves between the position indicator and a loop coil.

However, since the organic EL display apparatus of Japanese Patent Application Laid-Open No. H10-091342 is equipped with the pressure sensitive type touch panel, there are some possibilities that resolution of the position indicator (pen) becomes insufficiently low with respect to contact pressure (pen pressure) of the position indicator. Also, the pressure sensitive type touch panel must be arranged near the surface of the display apparatus, so that a total thickness of the display panel is increased by the thickness of this pressure sensitive type touch panel. As a result, a positional shift is produced between a pointed position of the position indicator (pen) and a display position, so that a so-called “parallax” may readily occur.

Also, in Japanese Patent Application Laid-Open No. S63-070326, since the position detecting apparatus has such a structure that the display apparatus including the substrate on which the loop coil used to detect a position of a position indicator is mounted is overlapped on the position detecting apparatus, a total thickness of the display panel is increased. As a result, the distance between the position indicator and the loop coil is increased. Thus, there are some risks that the position detecting precision and the position detecting sensitivity are lowered.

### SUMMARY OF THE INVENTION

The present invention has been made to solve the above-mentioned problems, and therefore, has an object to provide an EL display apparatus capable of improving position detecting precision and a position detecting sensitivity, and also capable of reducing parallax, while a thin type display apparatus having an electromagnetic induction type touch panel function can be constructed.

According to the present invention, there is provided an electroluminescence (EL) display apparatus having a coordinates detecting function, including: a first substrate provided with plural electroluminescence devices arranged on one surface of the first substrate; a second substrate provided with a loop coil used to detect coordinates arranged on one surface of the second substrate; a current detecting section for detecting a current change of the loop coil; and a coordinates detecting section for detecting a position on a display surface based on the current change detected by the current detecting section, in which: the plural electroluminescence devices are arranged along an X direction and a Y direction, which are two directions within the display surface respectively, the electroluminescence devices each including one pair of electrodes arranged on the first substrate and an organic compound layer arranged between the pair of electrodes; the loop coil includes first loop coils parallel-arranged in plural lines along the X direction and second loop coils parallel-arranged in plural lines along the Y direction; and the surface of the first substrate on which the electroluminescence devices are arranged is located opposite to the surface of the second substrate on which the loop coil is arranged.

According to the present invention, the EL devices are provided on the surface of the first substrate on the side of the second substrate, and the loop coils are provided on the surface of the second substrate on the side of the first substrate. Accordingly, both the EL devices and the loop coils are formed integrally as the EL display apparatus. As a consequence, the thin type EL display apparatus having the electromagnetic induction type touch panel function can be manufactured. As a result, position detecting precision and a position detecting sensitivity of the EL display apparatus can be improved, and parallax can be reduced.

Further features of the present invention will become apparent from the following description of exemplary embodiments with reference to the attached drawings.

### BRIEF DESCRIPTION OF THE DRAWINGS

FIG. 1 is a schematic diagram of an example of a sectional structure of an EL display apparatus according to an embodiment of the present invention.

FIG. 2 is a plan view for illustrating an example of a loop coil provided in the EL display apparatus of the above-mentioned embodiment.

FIG. 3 is a schematic diagram of an example of a sectional structure of an EL display apparatus according to another embodiment of the present invention.

FIG. 4 is a schematic diagram illustrating a structural example of a position indicator employed in the EL display apparatus according to this embodiment.

FIG. 5 is a schematic diagram illustrating another structural example of a position indicator employed in the EL display apparatus according to this embodiment.

### DESCRIPTION OF THE EMBODIMENTS

It should be noted that although embodiments of the present invention will be now described with reference to drawings, the present invention is not limited only to the embodiments.

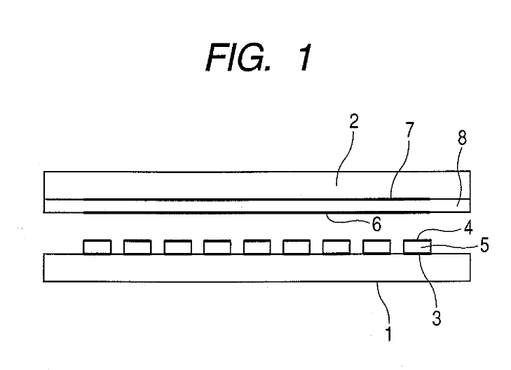

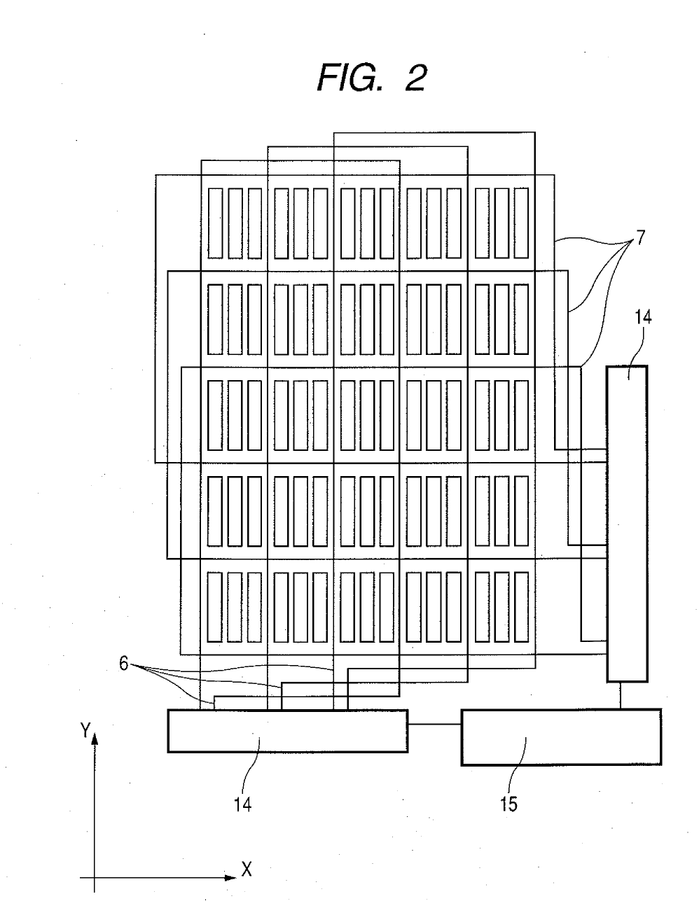

FIG. 1 is a schematic diagram of an example of a sectional structure of an electroluminescence (EL) display apparatus according to an embodiment of the present invention. FIG. 2 is a plan view illustrating an example of a loop coil provided in the EL display apparatus of the above-mentioned embodiment. In FIGS. 1, 2 and 3, there are provided a first substrate 1, a second substrate 2, a first electrode 3, a second electrode 4, an organic compound layer 5, a first loop coil 6, a second loop coil 7, an insulating layer 8, a current detecting section 14, and a coordinates detecting section 15.

In the EL display apparatus of this embodiment, the first substrate 1 and the second substrate 2 are arranged to be located opposite to each other, and an EL device is provided between the first and second substrates 1 and 2. The EL device includes one pair of opposing electrodes, that is, the first electrode 3 and the second electrode 4 and the organic compound layer 5 therebetween, which has at least a light emitting layer. The EL display apparatus according to the present invention corresponds to both a top emission type device for performing emission/display operations from a top surface side of a substrate, and a bottom emission type device for performing emission/display operations from a bottom surface side of a substrate. Also, the loop coils 6 and 7 are arranged on a surface of the second substrate 2, which is located on the side of the first substrate 1.

As previously described, since the EL display apparatus according to the present invention corresponds to both the top emission type device and the bottom emission type device, at least one of the first substrate 1 and the second substrate 2 may be essentially transparent with respect to light irradiated from the light emitting layer. Since the EL display apparatus illustrated in FIG. 1 is equipped with the top emission type device on the surface of the first substrate 1 opposing to the second substrate 2, only the second substrate 2 is constructed of an essentially transparent substrate in this embodiment. There is no specific limitation with respect to the first substrate 1 and the second substrate 2, but glass or an organic polymer may be employed.

At least one of the first electrode 3 and the second electrode 4 arranged on the display surface side is an electrode which is substantially transparent or semi-transparent and has light transmitting properties. The other electrode may have a reflectiveness and manufactured by a metal. Both the first electrode 3 and the second electrode 4 should have conducting properties and conduct a sufficiently large current capable of emitting the light emitting layer of the organic compound layer 5. As the reflection electrode, aluminum and silver may be employed. As the transparent electrode, indium tin oxide (ITO) and indium zinc oxide (IZO) may be employed. Alternatively, a metal material such as silver and aluminium may be made thin in such a degree that the thin metal material may have light transmitting properties so as to form a semi-transparent electrode. Further, a semi-transparent electrode may be combined with a reflection electrode, and also, an optical path length (namely, a thickness of organic compound layer) between those electrodes may be properly adjusted, so that a wavelength of emitted light may be adjusted and luminance may be increased due to a plural interference effect.

If the organic compound layer 5 containing the light emitting layer which emits light by being applied by the current is arranged between the first electrode 3 and the second electrode 4, there is no specific limitation of the structure thereof. The organic compound layer 5 may be made based on a stacked layer structure made of plural materials, for example, a multi-layer stacked layer structure including a hole transporting layer, a light emitting layer, an electron transporting layer, etc. Alternatively, the respective layers of the organic compound layer 5 may be made by mixing plural materials with each other. There is no specific restriction of emission colors of the light emitting layer, and any one of red (R), green (G), and blue (B) colors, namely, three primary colors of light, may be emitted. More specifically, a structure is employed in which light emitting layers capable of emitting R, G, and B color light are arranged on a display surface cyclically. In order to individually apply currents to the light emitting layers of the respective R, G, and B colors arranged cyclically, an active matrix circuit constructed of thin-film transistors (TFTs) can be employed. However, the present invention is not limited only to this active matrix circuit, but a passive matrix circuit may be alternatively provided.

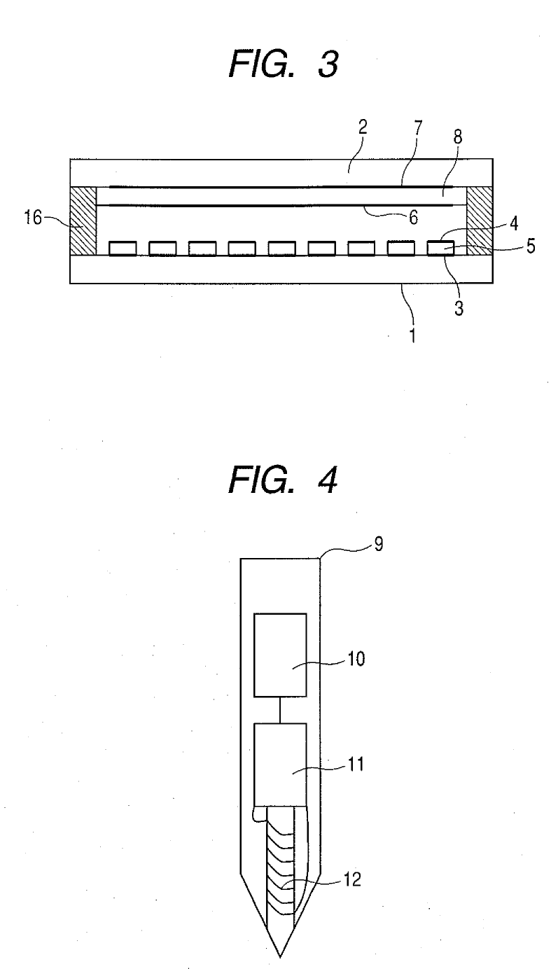

Specific gas such as air or inert gas may be sealed in a space between the first substrate 1 and the second substrate 2. As illustrated in FIG. 3, in order to support the first substrate 1 and the second substrate 2, a supporting solid body 16 may be arranged between the first substrate 1 and the second substrate 2. The supporting member is such a sealing member capable of preventing penetrations of moisture. In this case, the sealing member is arranged on peripheral portions of the first substrate 1 and the second substrate 2, and the EL device is arranged in a space defined by the first substrate 1, the second substrate 2, and the sealing member. In the case where the supporting solid body 16 is arranged between the first substrate 1 and the second substrate 2, and the side of the second substrate 2 corresponds to the display surface, it is desirable that the supporting solid body 16 is substantially transparent with respect to the light emission of the organic compound layer 5.

At least one of a plurality of first loop coils 6 and a plurality of second loop coils 7 is formed on the surface of the second substrate 2 opposing to the first substrate 1 (note that both first loop coil 6 and second loop coil 7 are formed in FIG. 1). The first loop coils 6 are arranged in plural lines side by side along pixel X direction of the display surface. The second loop coils 7 are arranged in plural lines side by side along pixel Y direction of the display surface. The first loop coils 6 and the second loop coils 7 correspond to circuits which transmit and receive electromagnetic waves with respect to a position indicator (input pen) 9 (described later). The loop of each of those circuits may be a closed circuit, or a partially opened circuit. Since the first and second coils 6 and 7, and the EL device are formed as an EL display apparatus integrally, a thin type EL display apparatus having a position detecting function of the position indicator 9 may be obtained. As described in the EL display apparatus illustrated in FIG. 1, when the side of the second substrate 2 constitutes the display surface, the EL device and the drive circuit thereof are not present between the first and second loop coils 6 and 7, and the display surface to which the position indicator 9 is to be in contact. As a consequence, while the power consumption is not increased, both precision and a sensitivity of the position detecting functions of the EL display apparatus can be improved.

The first and second loop coils 6 and 7 can be arranged so as to surround a partial area of the display section of the EL display apparatus. In the case where the position indicator 9 is located in the area surrounded by the first and second loop coils 6 and 7, the position of the position indicator 9 can be detected. As illustrated in FIG. 2, the first and second loop coils 6 and 7 can be arranged so as not to contain the light emitting area of the organic compound layer 5 of the EL device. In other words, such a structure is desirable that the first and second loop coils 6 and 7 are arranged between the adjacent light emitting areas. As described above, since the first and second loop coils 6 and 7 are arranged out of the light emitting area of the organic compound layer 5, absorption of light by the first and second loop coils 6 and 7 can be reduced, and the position detecting function can be installed while lowering of luminance as the EL display apparatus is minimized. The first and second loop coils 6 and 7 illustrated in FIG. 2 have been arranged in such a manner that the coils 6 and 7 surround the light emitting area of the organic compound layer 5 by one turn, but the present invention is not limited only thereto. The first and second loop coils 6 and 7 may alternatively surround the light emitting area in plural turns. Note that, in the case where the first and second loop coils 6 and 7 surround the light emitting area of the organic compound layer 5 in plural turns, substantially the same area can be surrounded in every turn.

Each of the first loop coils 6 and the second loop coils 7 may be arranged so as to partially overlap with each other. In other words, the plural first loop coils 6 are arranged side by side along the pixel X direction on the display surface of the EL display apparatus so that the plural first loop coils 6 are partially overlapped with each other. Similarly, the plural second loop coils 7 are arranged side by side along the pixel Y direction on the display surface of the EL display apparatus so that the plural second loop coils 7 are partially overlapped with each other. In the case where the first loop coils 6 and the second loop coils 7 are arranged side by side, an insulating layer 8 may be arranged between the first loop coils 6 and the second loop coils 7 in order to avoid an electric contact therebetween (refer to FIGS. 1 and 2). In a case where the second substrate 2 is made of a light transmitting material and light emitted from the light emitting layer is extracted through the second substrate 2, namely when the EL display apparatus corresponds to a top emission type structure, this insulating layer 8 is made of a reflection preventing member. Since the insulating layer 8 is made of such a reflection preventing member, light, which is entered from the outside, reflected from the electrode having the reflection properties which constitutes the EL device, and reflected from the second loop coils 7, can be prevented from being again returned to the outside. As a result, contrast of the EL display apparatus can be improved. As the reflection preventing member, for example, a circularly polarized light member may be adopted. This circularly polarized light member may be formed by stacking, for example, a polarized light member and a phase member on each other.

The EL display apparatus of this embodiment includes current detecting sections 14 and a coordinates detecting unit 15. The current detecting sections 14 detect current changes of the first and second loop coils 6 and 7 by transmitting and receiving electromagnetic waves with respect to the position indicator 9. The coordinates detecting unit 15 detects coordinates of a position where the position indicator 9 is located based on the detected current changes. The current detecting sections 14 are provided with the first loop coils 6 arranged side by side along the pixel X direction of the display surface, and the second loop coils 7 arranged side by side along the pixel Y direction of the display surface. Both of the current detecting units 14 are commonly connected to the coordinates detecting unit 15. A detailed description of the current detecting sections 14 and the coordinates detecting unit 15 will be made in the below-mentioned description of the position indicator 9.

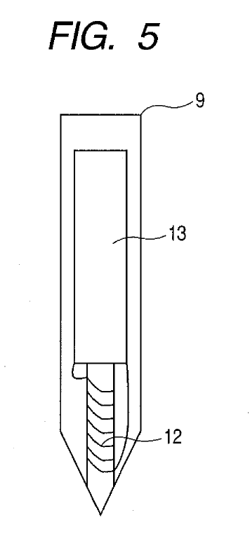

Next, a description is made of position indicators which are employed in the EL display apparatus of this embodiment. FIG. 4 is a schematic diagram illustrating one structural example of the position indicator employed in the EL display apparatus according to this embodiment. FIG. 5 is a schematic diagram illustrating another structural example of the position indicator employed in the EL display apparatus according to this embodiment. In FIGS. 4 and 5, there are provided a power supply 10, an oscillating circuit 11, a coil 12, and a tuning circuit 13.

If the position indicator 9 has a structure for transmitting and receiving electromagnetic waves with respect to the first and second loop coils 6 and 7, there is no specific limitation thereof. However, for example, the position indicator 9 can have a rod shape whose one tip portion is sharp, which is similar to, for instance, an input pen of a pen-input-type computer.

As a unit for transmitting and receiving the electromagnetic waves with respect to the first and second loop coils 6 and 7, the position indicator 9 may have an electromagnetic wave generating circuit which generates such electromagnetic waves capable of generating an induction current in at least one of the first loop coils 6 and the second loop coils 7 (refer to FIG. 4). In other words, the position indicator 9 has a function of generating electromagnetic waves, and is arranged in such a manner that an inducted electromotive force is generated in the first and second loop coils 6 and 7 in response to positions of the first and second loop coils 6 and 7, and a position of the position indicator 9. The position indicator 9 may be arranged in such a manner that at least one of a frequency and an amplitude of an electromagnetic wave generated by the position indicator 9 is changed in response to a force which is applied to the tip portion of the position indicator 9. As a consequence, process operations different from each other can be carried out in response to the force applied to the position indicator 9.

In the case where the position indicator 9 has the function of generating the electromagnetic waves, and causes the first and second loop coils 6 and 7 to generate the inducted electromotive force in response to the positions of the respective loop coils 6 and 7, and the position of the position indicator 9, the above-mentioned current detecting sections 14 are provided which have the function of detecting currents flowing through the respective loop coils 6 and 7. As a method for detecting the currents of the first and second loop coils 6 and 7, the currents flowing through all of the first and second loop coils 6 and 7 may be detected at the same time. Alternatively, one first loop coil 6 and one second loop coil 7 may be selected from the plural first and second loop coils 6 and 7, currents flowing through the selected loop coils 6 and 7 may be detected, and then the other loop coils 6 and 7 may be sequentially selected. Also, the current detecting sections 14 may be arranged so as to select and detect only a current having such a frequency which may be generated by the position indicator 9. Further, the coordinates detecting section 15 may acquire both the position of the position indicator 9 and the force applied to the tip portion of the position indicator 9 based on values of currents flowing through the respective loop coils 6 and 7, which are detected by the current detecting sections 14.

Also, as another unit for transmitting and receiving electromagnetic waves with respect to the first and second loop coils 6 and 7, the position indicator 9 may have a tuning circuit 13 (refer to FIG. 5). The tuning circuit 13 is tuned to electromagnetic waves which are generated by an AC current applied to at least one of the first loop coils 6 and the second loop coils 7. The frequency tuned by the position indicator 9 may be changed in response to the force applied to the tip portion of the position indicator 9. As a result, process operations different from each other may be carried out in response to the force applied to the position indicator 9.

In a case where the position indicator 9 includes the tuning circuit 13 which is turned to the electromagnetic waves generated by the first and second loop coils 6 and 7, the current detecting sections 14 may be provided which detect current changes with respect to AC voltages applied to the first and second loop coils 6 and 7. When the AC voltages are applied to the first and second loop coils 6 and 7 and the electromagnetic waves are generated therein, the currents flowing through the first and second coils 6 and 7 are changed by the tuning circuit 13 provided to the position indicator 9. Because the current changes are detected by the current detecting sections 14, the position of the position indicator 9 can be detected. Alternatively, the AC voltages applied to the first and second loop coils 6 and 7 may be detected by the current detecting sections 14.

Similarly, when the position indicator 9 of FIG. 5 is employed, voltages are applied to the first and second loop coils 6 and 7 at the same time, and current changes may be detected. Alternatively, one first loop coil 6 and one second loop coil 7 may be selected from the plural first and second loop coils 6 and 7; AC voltages are applied to the selected loop coils 6 and 7 so as to detect current changes, and then the other loop coils 6 and 7 may be sequentially selected. Further, voltages having plural frequencies may be applied to the first and second loop coils 6 and 7. The voltages having the plural frequencies may be applied to the first and second loop coils 6 and 7, but another voltage applying method may also be employed. That is, while time periods for applying the voltages having the respective frequencies are limited, the respective voltages may be applied periodically. In any voltage applying methods, the coordinates detecting section 15 may merely detect both the position of the position indicator 9 and the force applied to the tip portion of the position indicator 9 based on the current changes detected by the current detecting sections 14. In this example, the AC voltages are applied to the first and second loop coils 6 and 7 and the current detecting sections 14 detect the currents, but another arrangement may be alternatively conceived. That is, AC currents are applied to the first and second loop coils 6 and 7 and the current detecting sections 14 may alternatively detect voltages.

As previously described, according to the EL display apparatus of this embodiment, the plural EL devices are provided on the surface of the first substrate 1 opposing to the second substrate 2. Then, the first loop coils 6 parallel-arranged over the plural lines along the pixel X direction of the display surface, and the second loop coils 7 parallel-arranged over the plural lines along the pixel Y direction of the display surface are formed on the surface of the second substrate 2 opposing to the first substrate 1. As a consequence, while the EL devices, and the first and second loop coils 6 and 7 are formed integrally as the EL display apparatus, the thin type EL display apparatus having the electromagnetic induction type touch panel function can be formed. As a result, both the precision and the sensitivity of detecting a position on the EL display apparatus can be improved without increasing the power consumption, and the parallax can be reduced.

It should be noted that in the above-mentioned embodiments, such a structure has been described in which the layer arranged between the electrodes such as the light emitting layer is the organic compound layer, namely, a structure having the organic EL devices. The present invention is not limited only to the above-mentioned structure having the organic EL device, but may be applied to another structure having an inorganic EL device. When such an organic EL device is employed, a thickness of a light emitting layer can be easily made thinner than that of an inorganic EL device, so that a thinner type display apparatus can be manufactured.

Examples will be provided to describe the present invention in detail, but the present invention is not limited only the examples to be mentioned below.

### EXAMPLE 1

Referring to FIG. 1, an organic electroluminescence (EL) display apparatus of a first example will be described. In this example, the organic EL display apparatus is equipped with the first and second loop coils 6 and 7 having the structures of FIG. 2, and employs the position indicator 9 illustrated in FIG. 4.

As a first substrate 1, glass having a thickness of 1 mm was employed. TFT circuits were arranged on the first substrate 1 in a matrix shape, and drive signals were applied to drive circuits of an X axis and a Y axis. A desirable current was applicable with respect to a desirable pixel. An aluminium film was formed on the resulting first substrate 1 by vapor deposition and etched in a pixel shape to form a first electrode 3. A thickness of the first electrode 3 was 100 nm. An organic compound layer 5 containing a light emitting layer was vapor-deposited on the first electrode 3. Pixels for emitting the R, G, and B color light of the organic compound layer 5 were arranged cyclically. A thickness of the organic compound layer 5 was set to be 100 nm to 300 nm. An ITO film was formed on the organic compound layer 5 by vapor deposition as a second electrode 4. A thickness of the second electrode 4 was set to be 100 nm.

A transparent glass substrate having a thickness of 1 mm was employed as a second substrate 2. The first and second loop coils 6 and 7 having the structures illustrated in FIG. 2 were formed on the surface side of the second substrate 2 opposing to the first substrate 1. Since the first and second loop coils 6 and 7 were arranged so as to partially overlap with each other side by side, an electrode material was formed on the second substrate 2 by vapor deposition so as to form the shapes of the first and second loop coils 6 and 7. After that, an insulating layer 8 was arranged therebetween. A series of the above-mentioned processing steps are repeatedly carried out so as to manufacture a desirable structure. After that, current detecting sections 14 and a coordinates detecting section 15 were arranged on peripheral portions of the second substrate 2, and were electrically connected to the first and second loop coils 6 and 7.

Subsequently, while a positioning operation was carried out, the first substrate 1 was bonded to the second substrate 2.

The position indicator 9 illustrated in FIG. 4 was in contact with the display surface of the organic EL display apparatus from the side of the second substrate 2 in order to detect a position of operation as to the position indicator 9. The position indicator 9 illustrated in FIG. 4 included a power supply 10 and an oscillating circuit 11 therein. The oscillating circuit 11 had such a function that an oscillating frequency thereof was changed in response to a force which is applied to a tip portion of the position indicator 9. As a result, when the position indicator 9 was in contact with the organic EL display apparatus, induced electromotive forces were generated in one first loop coil 6 and one second loop coil 7, respectively. Those electromotive forces were detected by the current detecting sections 14. Such a crossed point of the first loop coil 6 whose induced electromotive force was the largest among those of the first loop coils 6 and the second loop coil 7 whose induced electromotive force was the largest among those of the first loop coils 7, corresponded to a point where the position indicator 9 was in contact with the organic EL display apparatus. This point was detected by the coordinates detecting section 15. With employment of the above-mentioned structure, the position of the position indicator 9 could be detected in a higher sensitivity.

### EXAMPLE 2

Referring to FIG. 1, an organic electroluminescence (EL) display apparatus of a second example will be described. In the second example, the organic EL display apparatus was equipped with the first and second loop coils 6 and 7 having the structures of FIG. 2, and employs the position indicator 9 illustrated in FIG. 5.

As a first substrate 1, transparent glass having a thickness of 1 mm was employed. TFT circuits were arranged on the first substrate 1 in a matrix shape, and drive signals were applied to drive circuits of an X axis and a Y axis. A desirable current was applicable with respect to a desirable pixel. An ITO film was formed on the resulting first substrate 1 by sputtering and etched in a pixel shape to form a first electrode 3. A thickness of the first electrode 3 was 200 nm. An organic compound layer 5 containing a light emitting layer was vapor-deposited thereon. Pixels for emitting the R, G, and B color light of the organic compound layer 5 were arranged cyclically. A thickness of the organic compound layer 5 was set to be 100 nm to 300 nm. An aluminium film is formed on the organic compound layer 5 by vapor deposition as a second electrode 4. A thickness of the second electrode 4 was set to be 100 nm.

A glass substrate having a thickness of 1 mm was employed as a second substrate 2. The first and second loop coils 6 and 7 having the structures illustrated in FIG. 2 were formed on the surface side of the second substrate 2 opposing to the first substrate 1. Since the first and second loop coils 6 and 7 were arranged so as to partially overlap with each other side by side, an electrode material was vapor-deposited on the second substrate 2 so as to form the shapes of the first and second loop coils 6 and 7. After that, an insulating layer 8 was arranged therebetween. A series of the above-mentioned processing steps were repeatedly carried out so as to manufacture a desirable structure. After that, current detecting sections 14 and a coordinates detecting section 15 were arranged on peripheral portions of the second substrate 2, and were electrically connected to the first and second loop coils 6 and 7.

Subsequently, while a positioning operation was carried out, the first substrate 1 was bonded to the second substrate 2.

The position indicator 9 illustrated in FIG. 5 was in contact with the display surface of the organic EL display apparatus from the side of the second substrate 2 in order to detect a position of operation as to the position indicator 9. The position indicator 9 illustrated in FIG. 5 included a tuning circuit 13 therein. A tuning frequency of the tuning circuit 13 was changed in response to a force applied to a tip portion of the position indicator 9. As a result, when the position indicator 9 was in contact with the organic EL display apparatus, an impedance of one first loop coil 6 and an impedance of one second loop coil 7 were changed. In other words, currents when an AC voltage was applied to the first loop coils 6 and the second loop coils 7 were changed. Such a crossed point of the first loop coil 6 whose current change was the largest among those of the first loop coils 6 and the second loop coil 7 whose current change was the largest among those of the second loop coils 7 corresponded to a point where the position indicator 9 was in contact with the organic EL display apparatus. This current change was detected by the current detecting sections 14, and the coordinate detecting section 15 detected a position on a display surface based on the current change detected by the current detecting section 14. With employment of the above-mentioned structure, the position of the position indicator 9 could be detected in a higher sensitivity.

The EL display apparatus according to the present invention may be applied to a computer and a display apparatus of a portable information terminal each having a pen input function.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-048002, filed Feb. 24, 2006, and 2007-025234, filed Feb. 5, 2007, which are hereby incorporated by reference herein in their entirety.

What is claimed is:

1. An electroluminescence display apparatus having a coordinates detecting function, comprising:
a first substrate provided with plural electroluminescence devices arranged on one surface of the first substrate;
a second substrate provided with a loop coil used to detect coordinates arranged on one surface of the second substrate;
a current detecting section for detecting a current change of the loop coil; and
a coordinates detecting section for detecting a position on a display surface based on the current change detected by the current detecting section, wherein:
the plural electroluminescence devices are arranged along an X direction and a Y direction, which are two directions within the display surface respectively, the electroluminescence devices each including one pair of electrodes arranged on the first substrate and an organic compound layer arranged between the pair of electrodes;
the loop coil includes first loop coils parallel-arranged in plural lines along the X direction and second loop coils parallel-arranged in plural lines along the Y direction; and
the surface of the first substrate on which the electroluminescence devices are arranged is located opposite to the surface of the second substrate on which the loop coil is arranged.

2. The electroluminescence display apparatus according to claim 1, wherein an insulating layer is provided between the first loop coils and the second loop coils.

3. The electroluminescence display apparatus according to claim 1, wherein:
the second substrate comprises a light transmitting member, and light emitted from a light emitting layer is taken out through the second substrate; and
the insulating layer comprises a reflection preventing member.

4. The electroluminescence display apparatus according to claim 1, wherein:
a sealing member is provided on peripheral portions of the first substrate and the second substrate; and
the electroluminescence devices are arranged within a space defined by the first substrate, the second substrate, and the sealing member.
